(19) United States
(12) Patent Application Publication
(10) Pub. No.: US 2006/0182849 A1
(43) Pub. Date: Aug. 17, 2006

(54) Low carb Omega 3 food coating composition and method of making thereof

(76) Inventors: Janusz Wojciak, Calgary (CA); Dinesh Bhatnagar, Calgary (CA)

Correspondence Address: Janusz Wojciak, 126 Somerglen Close SW, Calgary, AB, T2Y 3Z5, CA

(21) Appl. No.: 11/059,030

(22) Filed: Feb. 17, 2005

(51) Int. Cl. A21D 13/00

(52) U.S. Cl. 426/94

(57) ABSTRACT

The inventions pertains to a specific coating composition and as well as a conformation of the coat on a specific substrate and a method of making such coated products. The resulting product can be baked or fried using non-hydrogenated oil and frozen. Due to the high content of vegetable oil in the coating composition, it can be manufactured without the use of any frying oils, as a result no trans-fatty acids are present in the product. A natural antioxidant is added to the coating composition allowing extended time of frozen storage. The frozen product can be reconstituted in microwaves in addition to traditional frying or ovens. The product manufactured and reconstituted using described coating, substrate and preparation method would be a heart healthier due to the fact that it would deliver recommended daily intake of over 3 grams of essential Omega 3 unsaturated acids and healthy lignan components and reduced amount of carbohydrates in one more serving portions. Since the product can be reconstituted in microwave in less then 2 minutes, delivering excellent eating quality it is particularly suited for healthy fast food and a food for any eating occasion.

### FILED OF THE INVENTION

The invention relates to the composition of a food coating material used to create an edible and healthy shell imitating a bun or bread and embracing a food substrate. The final product is having a an oval, round or square shape of a hamburger or shape of a cylinder or a cylindrical ring and a method of making thereof. The product is a frozen fully cooked foodstuff that is reconstituted in the microwave energy and having healthy functional components and a high eating quality, good texture and overall palatability. The invention also relates to such food coating material that contains a flax seed meal stabilized by a heat treatment that delivers a daily recommended intake of essential Omega-3 fatty acids and other healthy components in one or multiple serving portions.

### DESCRIPTION OF THE PRIOR ART

Currently most breaded food products are manufactured using food substrates such as meat, fish poultry and vegetables using coating which mainly contain ingredients such as flour, breadcrumbs, protein isolates, egg products, leavening agents and spices and seasonings and salt. Such coated products are mostly fired in hydrogenated oils, frozen and reconstituted either in fryer or household ovens and eaten either as center of the plate items or sandwiches. Examples will include chicken fingers, breaded chicken burgers, breaded veal or pork cutlet. The food products made using current technology have several negative features from health and convenience point of view. The carbohydrate content of these products tends to be high, the fats used to fry the products tend to have high amounts of trans-fatty acids and if reconstituted in microwave ovens tend to be soggy and have poor eating quality.

There is increasing interest in the concept of “functional foods”, which the FDA defines as foods that by virtue of physiologically active components provide benefits beyond basic nutrition and may prevent disease and promote health. Because of a demographic trend to an increasing senior population, there is a tending urgency for the development of functional foods to facilitate a healthier lifestyle.

Different restaurants and retail grocery stores offer wide range of food products that are designed to satisfy basic nutritional needs of people that do not have time to prepare their own breakfast, lunch or dinner. The segment of the industry called fast food industry is supplying such ready meals or sandwiches in multiple public outlets is lacking in their offer functional foods products. Considerable proportions of the fast food products consumed are battered and breaded meat and fish products. There is also a considerable consumer demand for this type of coated products such as coated portions of meat, poultry, vegetables or fish. Usually, these products are obtained by first pre-dusting it with a plant flour, dipping a raw, partially cooked or cooked, optionally frozen, product in a water bath or a batter consisting of a mixture of water and various plant flours, thus enrobing with a fluid substance and, subsequently to wetting, applying a particulate breading material. If desired, the steps of wetting and breading can be repeated to obtain a multi-layered coating. Before storage the coating may be stabilized, for instance by pre-frying or baking in the convection oven.

Commonly known crumb coating materials contain particles of a heat-treated starchy material. Bread crumbs are made by baking of a loaf of bread which, after staling, is ground into conventional breading material. Another method involves the cooker extrusion of a mixture of flour and water, for instance to obtain so-called Japanese crumbs. Crumb coated products are often stored at frozen conditions. For consumption the products are heated, for instance by deep or shallow fat frying, oven baking, roasting, microwave heating or grilling.

A coating composition for foods that contains high level of rice (e.g., as flour) and dextrin, and little or no cornstarch, with the rice and dextrin components is described in Canadian Patent Application C.A. 2398845 Feb. 7, 2001. The high amounts of both rice and dextrin substantially increase the coated product's crispness and holding time after either complete initial cooking or secondary reconstitution in conventional or microwave oven after limited initial cooking (e.g., parfrying) and freezing, while maintaining good appearance, taste. Another food coating compositions having an ability to produce crisp, brown coatings on food products cooked in conventional convection ovens and especially in microwave ovens comprise conventional coating ingredients such as flour, starch, sodium chloride, carbohydrates, spices and herbs and at least one additional salt ingredient is known from Canadian Patent C.A. 1184413 Feb. 10, 1983. Another invention described in Canadian Patent Application CA 2435746, Jan. 22, 2002, pertains to the use of a degraded and cross-linked starch in a food coating or batter composition for food products.

Frozen food product described in Canadian Patent CA 1219763, Feb. 12, 1985 is a coating composition which permits the food product to be reconstituted for consumption by the application of microwave energy and obtain the desired combination of textural properties, both of moistness of food substrate and crispness of coating. The coating composition comprises three components, namely a predust component applied to the food substrate, a batter component next applied to the food substrate, and finally a carbohydrate breading component. Another example of a microwave cookable coating that comprises an aqueous mixture of starch, cellulose gum, flour, enzyme additive and additional ingredients wherein the enzyme additive comprises one or more alpha amylases optionally together with one or more further enzymes is revealed in Canadian Patent Application CA 2189670, Apr. 26, 1995.

One of the major disadvantages of using of this type of coatings is that the shell created around the substrate, which is usually nutritionally higher value meat of fish product, contains considerable amounts of carbohydrates. The weight of the coating represents between 20% and 50% of the total weight of the product. This type of coats may contain from 60% to 80% of carbohydrates. When carbohydrates are eaten and digested they are broken down into glucose. Glucose in the blood stream (blood sugar) needs to be regulated. It is known that too much causes hyperglycemia, too little causes hypoglycemia. The body uses some of the glucose immediately as energy, and stores the excess as glycogen and fat. Hormones produced in the pancreas, namely insulin and glucagon, regulate glucose. High blood sugar causes insulin to be released. Low blood sugar causes glucagon to be released, which in turn releases some of the stored-up glycogen. When energy demand by the body is high, glucose (fuel) is released. When the body is resting glycogen is stored either a quick source of energy, or as fat for long term demand. But if an overload of carbohydrates is eaten without a corresponding increase in activity, turning the glucose into fat is the quickest and easiest way for the body to store the excess. Scientific studies indicate that reducing total amount of carbohydrates in human diet is advantageous for humans. As those excessive carbohydrates are consumed in North America mainly as snacks or fast food meals, replacing them in those foods with a healthier substitute would have considerable effect on overall health of consumers.

Current nutrition research continues to identify various substances in foods that act as protectors against chronic illnesses like cardiovascular disease and cancer. Flax seed is a popular food ingredient in Europe and Canada. Several studies confirm that flax seed can be a cholesterol-lowering agent like oat bran, fruit pectin and other food ingredients that contain soluble fiber. By packaging both Omega-3 fatty acids and soluble fiber together, flax seed presents two ingredients that favor healthy blood lipid patterns.

Flax seed contains healthy amounts of healthy both soluble and insoluble fiber. Scientists at the American National Cancer Institute singled out flax seed as one of six foods that deserved special study. It was found that the flax seed shows potential cancer-fighting ability. Flax seed is one of the richest sources of lignans, a type of phytoestrogen, which may protect against cancer, particularly hormone-sensitive cancers such as those of the breast and prostate. Eating 50 grams of flax seed per day (baked into muffins) helped increase the frequency of bowel movements and the number of consecutive days with bowel movements in a group of older Canadian adults. Total cholesterol levels dropped 9 percent and LDL (the “bad” cholesterol) decreased 18 percent when a group of nine healthy women ate 50 grams of milled flax seed a day for four weeks (as flour or cooked into bread) along with their regular diets, according to a report from the University of Toronto. In a similar study with men and women, 50 grams of flax seed (eaten daily in muffins) lowered total cholesterol and showed a constant trend of about 11 to 16 percent lower serum lipids (fat in the blood). Lignans and alpha-linolenic acid are found abundantly in flax seed. Population studies of diet and disease risk suggest an anticancer role for flax seed.

It is reported that eating more Omega-3 fats helps ward off fatal heart attacks, autoimmune diseases like rheumatoid arthritis, sever menstrual cramps and depression. Many researchers report that the modern diets, even healthy ones, are routinely deficient in Omega-3s.

Fatty Acid Composition of Flax Seed Oil:

| | |
|---|---|
| Saturated fatty acids | 9% |
| Monounsaturated | 18% |
| Polyunsaturated: | |
| Omega-3 fatty acids | 57% |
| Omega-6 fatty acids | 16% |
| Total | 100% |

More than half the fat in flax seed is of the essential Omega-3 fatty acid type. Scientific studies reporting health benefits for Omega-3 fatty acids show that these fatty acids are required for proper infant growth and development. Adding flax seed to the diet can reduce cholesterol. New research also suggests that alpha-linolenic acid, an Omega-3 fatty acid which is abundant in flax seed, offers protective effects against both coronary heart disease and stroke. Omega-3s have been shown to also protect against hypertension, and inflammatory and autoimmune disorders. Long-term studies of flax seed effects on breast cancer are now underway. An essential fatty acid, linoleic is the chief polyunsaturated fat in the North American diet. Currently, researchers and nutrition experts recommend people replace some Omega-6 fatty acids in their diet with Omega-3 fatty acids like those found in flax seed.

Known is the cancer-fighting ability of lignans. Flax seed is one of the richest sources of lignans in the plant kingdom. Most of the soluble fiber in flax seed is mucilage, a thick, sticky substance. Few studies have looked at the direct effects of flax seed mucilage on health. But studies show that eating flax seed (baked into muffins and breads) can lower blood cholesterol levels.

Alpha-linolenic acid contained in the whole or milled flax seed was found to be stable to heat at temperatures involved in baking batters and doughs such as muffins and yeast bread. There were no significant changes in peroxide values and fatty acid composition when both forms of flax seed were heated for 60 minutes at either 100° C. (212° F.) or 350° C. (662° F.). Further studies confirmed the stability of alfa-linolenic acid in baked muffins containing the same amount of milled flax seed and noted that thiobarbituric acid values, as estimates of alfa-linolenic acid oxidation were also unaffected by baking (Cunnane S C, et al. Am J Clin Nutr. 1995; 61:62-68). Bread, muffins and pizza dough containing 6.9, 8.0 and 13.2% flax seed respectively, were baked at 190° C. (375° F.). In both commercial and homemade categories, lignan production reflected the amount of flax seed added. This was also the case in pancakes enriched with 6.2% flax seed, which were griddle-baked at 205° C. (400° F.). Studies proved that the lignan availability in flax seed is stable to customary baking temperatures.

There are many ways of introducing flax seed to food products. Ground flax seed can be sprinkled into hot or cold cereal, yogurt, salad dressing, soup or fruit juice just before the food is consumed. Another way is adding it to the dough e.g. with muffin or donut flours and bake it in the convection oven.

The disadvantage of this type of culinary application is that the added ground flax seeds may adversely affect the flavor and texture of food products. Raw flax seed added to fresh food products is easily recognized as a new and inferior additive compromising the eating quality of known food products. Addition of flax seed to baked products is also adversely affecting eating quality of baked goods because a distinctive nutty or oily flavor of flax and different texture created by it addition are recognized and disliked by the consumers. Another disadvantage is that flax can only be added in limited amounts in order not to change the eating quality of existing food products and decrease their salability. Consequently, products containing flax seed represent a small fraction of commercially manufactured food products in North America and a special nutritional advertising is required to enhance consumers to draw their interest. Currently, products containing flax seed are frequently categorized as functional foods and their distribution is limited to consumers that are dieting or seeking healthy or organic type of food products.

According to the present invention, a convenient way of introducing flax seed meal into food products is developed wherein a healthy, flax seed coating with low content of carbohydrates is created on various fast food products. The coating is stabilized by a heat treatment and subsequently coated product is frozen and kept fore an extended period of time without losing biological, nutritional value of components of the flax meal coating. Due to its visual characteristics reminding traditional buns or bread and high content of healthy essential Omega 3 fatty acids and lignans, it allows a large-scale consumption of such products which is beneficial to average fast food consumers.

In these respects, the healthy food coating composition according to the present invention substantially departs from the conventional concepts and designs of the prior art, and in so doing provides a healthy alternative or substitute that can be prepared quickly and easy, saving time and cutting manufacturing, distribution and preparation cost.

The instant invention seeks to build a low carbohydrate bun-like and/or bread-like structure from a ground flax seed by agglomeration which is suitable for conventional adhesion to a food comestible with a batter system. It has been found that novel coatings manufactured using agglomeration techniques are significantly improved with respect to their quality, particularly after microwave heating.

Recent studies on the potential cholesterol-raising effects of trans fatty acids have raised public concern about the use of hydrogenated polyunsaturated oils in commercial fryers and as an additive to various flours and breading materials. Due to the high content of vegetable oil in the coating composition, there is no need to use frying oil in the manufacturing process. Heat induced stabilization of the coating can be performed in the convection oven, thus no trans-fatty acids are transferred to the product.

### OBJECTIVES AND SUMMARY OF THE INVENTION

It has been recognized that it would be advantageous to utilize ground flax seed as a major component of a coating of food products allowing to substitute more expensive and nutritionally deficient, carbohydrate based bread crumbs, cracker meal and other flours with a healthy alternative one. In addition, it has been recognized that it would be advantageous to use ground flax seed in coating composition in order to supply a daily recommended intake of Omega-3 essential fatty acids, mainly alpha-linolenic acid, and increased intake of lignans and soluble and insoluble fiber.

It has been recognized that incorporating substantial amounts of flax seed and its healthy components into a fast food products that are preferentially eaten in on a massive scale in North America as snacks, sandwiches or major components of fast food restaurants meals can contribute to improvement of fast food consumers' health, protect them against both coronary heart disease and stroke. Omega-3s have been shown to also protect against hypertension, and inflammatory and autoimmune disorders. Modern diets—even healthy ones—are routinely deficient in Omega-3s essential fatty acids.

The coating with ground flax seed instead of conventional breadcrumbs and similar cracker meal components allows reduce the amount of carbohydrates in the diet and preserve a traditional texture and consistency, but without traditional messiness, high cost of components, excessive labor involved in the manufacturing process. In addition, it has been recognized that it would be advantageous to develop a method for making such healthy coating composition.

It has been recognized that the novel food coating composition can be manufactured without the usage of hydrogenated polyunsaturated oils, thus the product contains no trans-fatty acids.

### SPECIFICATION

The invention provides a food coating composition that is covering a substrate of protein material like cooked muscle meat, meat emulsion or textured plant protein mixed with spices, having a an oval, round or square shape of a hamburger or shape of a cylinder or a cylindrical ring. The substrate portion is surrounded by an edible shell created of layers of food materials wherein the external layer consists mainly of ground flax seed that may be mixed with a proportion of bread crumbs, flour, spices and having a shape of the said substrate and a substantially continuous wall forming an integral shell and cavity that embraces and adhering to the aforementioned substrate.

In accordance with one aspect of the present invention, covering the substrate with flour creates the first layer, second layer is created by dipping dusted substrate in a batter consisting of a mixture of water and various plant flours. Covering the battered substrate with a ground flax seed or mixture of flax seed and other breading material creates the final layer.

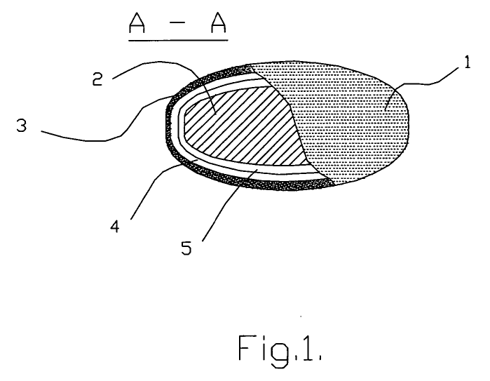

FIG. 1 is a cut away AA section of the coated food product (1) consisting of the substrate (2) and surrounded by an edible shell created of layers of food materials wherein the external layer (3) consists mainly of ground flax seed that may be mixed with a proportion of bread crumbs, flour, spices and having a shape of the said substrate and a substantially continuous wall forming an integral shell and cavity that embraces and adhering to the aforementioned substrate. The second layer (4) consists of a mixture of water and soy protein concentrate and the first layer (5) covers the substrate and may consist of flour, spices, proteins and other additives that are absorbing excessive moisture from the substrate and enhancing adhesion of the other layers and substrate.

In accordance with another aspect of the present invention, the first layer components of the food coating composition comprise wheat gluten, salt, spice extract, whey and dextrose. The second layer components comprise soy protein concentrate and water. The said layer is a liquid batter type material adhering and separating the first and third, external layers. Mixing about 10 parts of protein batter forming material and 90 parts of water creates the batter. Temperature of the batter used to cover food substrate should be maintained at about 4.4° C. (40° F.) to 10° C. (50° F.). The third layer components comprise essentially 100% or less of ground flax seed. Some other breader components like breadcrumbs, flour, corn starch, chemical leavening agent and seasonings like salt and pepper may be added to improve eating quality of the finished product.

In order to enhance a visual effect on the surface of the food coating external layer, about 10% to 20% of whole flax seed can be added to the ground one. Rosemary herbal antioxidant may be mixed into the third layer components, in order to extend the shelf life of the finished product. Addition of natural antioxidant to the ground flax seed is preventing the oxidation of unsaturated fatty acids, including Omega 3 acids, thus the oxidative rancidity is inhibited for extended period of frozen storage time of coated products.

In accordance with another aspect of the present invention, the first layer comprise 2% to 5% weight, the second layer comprise 20% to 27% weight and the third layer comprise 10% to 30% of the total food product. The coating comprise 30% to 50% total product weight. Each layer is separately and mechanically put on the substrate, wherein the coating shell is stabilized and crust consistency is created by heat treatment in a deep fat fryer for 10 to 30 seconds at a temperature from 182° C. (360° F.) to 199° C. (390° F.) and/or preferentially baked in a convection oven for 5 to 12 minutes at a temperature from 232° C. (450° F.) to 288° C. (550° F.), without prior blanching in oil, until the substrate is fully cooked until the temperature in the center of the product reaches between 71° C. (160° F.) and 82° C. (180° F.) and the coated product is frozen. Finished products are suitable for reconstituting in microwave ovens and they require 1 to 2 minutes reheating. The frozen food product contains substrate, which may be is a ground chicken mixed with about 5% to 25% water and 0.5% to 1.5% salt and phosphates. The substrate comprises 60% to 65% of the total product weight and said first, second and third coating layers comprise respectively: 2% to 5%, 20% to 25% 10% to 30% of the total food product. Other meats that can be used to prepare substrate part are pork and beef. The shape of the finished product may be similar to a patty, hamburger, fingers, nuggets, cutlets, cylinders and the serving size may be between 5 to 250 grams and allowing to deliver daily recommended amount of Omega 3 fatty acids in a single or multiple serving portions.

TABLE 1
Proportions of the major components of
an exemplary food coating composition

| | Weight | |
|---|---|---|
| Description | [grams] | Proportion |
| Substrate | 140.00 | 63.21 |
| Substrate and 1^{st} layer | 144.45 | 65.21 |
| 1^{st} layer: flour - Dust | 4.45 | 2.01 |
| Substrate and 2^{nd} layer | 196.8 | 88.85 |
| 2^{nd} layer: Batter | 52.35 | 23.63 |
| Substrate and 3^{rd} layer | 221.50 | 100.00 |
| 3^{rd} layer: Flax seed | 24.70 | 11.15 |

TABLE 2
Proportions of the ingredients used to formulate
the exemplary food coating composition

| | | Pro- | | |
|---|---|---|---|---|
| Formula | | portions | Weight | |
| component | Ingredients | [%] | [grams] | Description |
| Substrate | Chicken meat, | 63.21 | 140.00 | |
| | pork or beef | | | |
| Layer 1 | Wheat flour | 1.00 | 1.86 | Pre-dust |
| | Wheat gluten | 0.20 | 0.37 | |
| | Salt | 0.50 | 0.93 | |
| | Spice extract | 0.30 | 0.56 | |
| | Whey | 0.27 | 0.50 | |
| | Dextrose | 0.10 | 0.19 | |
| Layer 2 | Water | 21.27 | 47.12 | Soy protein |
| | Soy Protein | 2.36 | 5.24 | concentrate mixed |
| | Concentrate | | | thoroughly with |
| | | | | water. Batter is |
| | | | | created. |
| Layer 3 | Golden | 10.59 | 23.47 | Covering the |
| | flax seed | | | dusted and battered |
| | Seasoning | 0.56 | 1.24 | substrate |

Nutritional information of an exemplary coating composition compared to an exemplary chicken substrate and a regular sandwich bun are presented in table 3.

TABLE 3
Nutritional information of the exemplary coating composition,
chicken substrate and a regular sandwich bun.

| | | Chicken | Regular | |
|---|---|---|---|---|
| | Coating | Substrate | Sandwich Bun | Units |
| Serving size | 81.5 | 140.0 | 58.0 | Gram |
| Calories | 148.0 | 146.0 | 160.0 | Kcal |
| Protein | 12.6 | 27.0 | 4.8 | Gram |
| Carbohydrates | 8.1 | 0 | 31.0 | Gram |
| Dietary Fiber | 3.2 | 0 | 1.3 | Gram |
| Net Carbs -Digestible | 4.9 | 0 | 29.7 | Gram |
| Carbohydrates | | | | |
| Fat | 8.6 | 6.0 | 1.8 | Gram |
| Saturated Fat | 0.6 | 1.0 | 0.4 | Gram |
| Monounsaturated Fat | 1.5 | 1.0 | 0.4 | Gram |
| Polyunsaturated Fat | 4.7 | 1.0 | 0.9 | Gram |
| Trans Fatty Acids | 0 | 0 | 0 | Gram |
| Omega 3 Fatty Acids | 3.6 | 0 | 0 | Gram |
| Omega 6 Fatty Acids | 1.1 | 0 | 0 | Gram |
| Omega 9 Fatty Acids | 0.5 | 0 | 0 | Gram |

In accordance with another aspect of the present invention, the novel coating composition represents much healthier choice as compared to a standard sandwich bun. A single serving portion weighing 81.5 gram delivers 3.6 grams of Omega 3 fatty acids, 3.2 grams of dietary fiber and 4.9 grams of digestible carbohydrates. Main source of nutritional value added to the food coating composition is the third layer that, depending on the serving size, comprises 5 to 30 grams of ground flax seed. This layer delivers the Omega 3 fatty acids, which comprises about 4% to 5% of total coating weight and about 10% to 20% of the weight of third layer.

What we claim is:

1. A food coating composition created by covering the food substrate with a first layer of wheat flour then a second layer of mixture of wheat flour or soy protein concentrate and water and the third layer consisting of 100% or less ground flax seed, bread crumbs, flour, corn starch, chemical leavening agent and seasonings, salt and pepper.

2. A food coating composition of claim 1 wherein the first layer components comprise wheat gluten, salt, spice extract, whey and dextrose.

3. A food coating composition of claim 1 wherein the second layer components comprise soy protein concentrate and water.

4. A food coating composition of claim 3 wherein about 10 to 12 parts of protein batter forming material is used for about 88 to 90 parts of water.

5. A food coating composition of claim 1 wherein the substrate is covered with the said coating and formed into a shape a hamburger, nugget, finger, cylinder or ring having a diameter of up 5 inches and thickness of up to 2 inches weighing 10 to 250 grams.

6. A food coating composition of claim 5 wherein the third layer comprises 5 to 25 grams of ground flax seed.

7. A food coating composition of claim 5 wherein the third layer delivers the Omega 3 fatty acids, which comprises about 4% to 5% of total coating weight and about 10% to 20% of the weight of third layer.

8. A food coating composition of claim 5 wherein between 10% to 20% of the flax seed may be a whole flax seed added to enhance a visual effect on the surface of the food coating external layer.

9. A food coating composition of claim 1 wherein the third layer components comprise about 1% to 2% Rosemary herbal antioxidant mixed with the said layer components of claim 5 to extend the shelf life of the finished products.

10. A food coating composition of claim 1 wherein the first layer comprise 2% to 5% weight, the second layer comprise 20% to 25% weight and the third layer comprise 10% to 30% of the total food product.

11. A food coating composition of claim 1 wherein the coating comprise 30% to 50% total product weight.

12. A food coating composition of claim 1 wherein the each layer of claim 1 is mechanically put on the substrate, wherein the coating shell is stabilized and crust consistency is created by heat treatment in a baking oven for 5 to 12 minutes at a temperature from 232° C. (450° F.) to 288° C. (550° F.), until the substrate is fully cooked to the temperature between 71° C. (160° F.) and 82° C. (180° F.).

13. A food coating composition of claim 12 wherein the coating shell is stabilized and crust consistency is created by heat treatment in a baking oven and no trans-fatty acids are present in the product.

14. A food coating composition of claim 1 wherein such coating may be partially cooked in a deep fat fryer for 10 to 30 seconds at a temperature from 182° C. (360° F.) to 199° C. (390° F.) and then baked and the coated substrate is frozen.

15. A frozen food product suitable for reconstituting in microwave energy wherein a food substrate is about 50% to about 70% and a food coating composition is about 30% to 50% of the total product weight.

16. A frozen food product of claim 13 wherein a food substrate is a ground chicken that may be mixed with about 5% to 25% water and 0.5% to 1.5% salt and phosphates and comprises 60% to 65% of the total product weight and said first, second and third coating layers comprise respectively: 2% to 5%, 20% to 25% 10% to 30% of the total food product.

17. A frozen food product of claim 13 wherein a food substrate is pork meat that may be mixed with about 5% to 25% water and 0.5% to 1.5% salt and comprises 60% to 65% of the total product weight and said first, second and third coating layers comprise respectively: 2% to 5%, 20% to 25% 10% to 30% of the total food product.

18. A frozen food product of claim 13 wherein a food substrate is beef meat that may be mixed with about 5% to 25% water and 0.5% to 1.5% salt and comprises 60% to 65% of the total product weight and said first, second and third coating layers comprise respectively: 2% to 5%, 20% to 27% 10% to 30% of the total food product.

19. A frozen food product of claim 13 wherein the substrate portion is surrounded by an edible shell created of layers of food materials wherein the external layer having a shape of the said substrate and a substantially continuous wall forming an integral shell and cavity that embraces and adhering to the aforementioned substrate.

20. A frozen food product of claim 13 wherein the shape of the said product may be similar to a patty, hamburger, fingers, nuggets, cutlets, cylinders and the serving size may be between 5 to 250 grams and allowing to deliver daily recommended amount of Omega 3 fatty acids in a single or multiple serving portions.
